(19) United States
(12) Patent Application Publication
(10) Pub. No.: US 2002/0115444 A1
(43) Pub. Date: Aug. 22, 2002

(54) Systems and methods wherein a base device facilitates a determination of a location associated with an occurrence of an event

(76) Inventors: Philip S. Yu, Chappaqua, NY (US); Edith H. Stern, Yorktown Heights, NY (US); Barry E. Willner, Briarcliff Manor, NY (US); David P. Greene, Ossining, NY (US)

Correspondence Address: BUCKLEY, MASCHOFF, TALWALKAR, & ALLISON, 5 ELM STREET, NEW CANAAN, CT, 06840, US

(21) Appl. No.: 09/784,975

(22) Filed: Feb. 16, 2001

(51) Int. Cl. H04Q 7/20

(52) U.S. Cl. 455/456; 455/450

(57) ABSTRACT

Systems and methods are provided wherein a base device facilitates a determination of a location associated with an occurrence of an event. A location of the base device is determined, and the base device receives information from an event device. For example, a device in a police automobile may receive information from a police handgun via a wireless communication. Information is then stored to enable a determination of a location associated with an occurrence of an event.

### FIELD

The present invention relates to a determination of a location associated with an occurrence of an event. In particular, the present invention relates to systems and methods wherein a base device facilitates the determination of the location associated with the occurrence of the event.

### BACKGROUND

It is often extremely important to be able to determine when and where an event has occurred. Consider, for example, a police officer who discharges his or her handgun. In this case, it may be important to determine when and where the handgun was discharged in order to provide evidence against a suspect. Moreover, knowing when and where the handgun was discharged can even help demonstrate that the officer acted properly. Similar concerns can apply when a police officer uses other types of weapons (e.g., a stun gun or a defensive chemical spray).

As another example, it may be important to determine when and where an automobile accident has occurred. Such a determination may help support, or contradict, a driver's version of how the accident took place. Similarly, it may be important to determine where an emergency vehicle (e.g., a fire truck or ambulance) is located during an emergency.

As still further examples, it may be important to determine where a customer is when a transaction occurs (e.g., to determine whether or not the customer is in a region where such a transaction is prohibited) or where a competitor is at a particular point in a competition (e.g., during a marathon).

It is known that a device can communicate with other devices to determine a location. For example, it is known that a Global Positioning System (GPS) receiver can receive information from satellites in order to determine a location.

There are a number of disadvantages, however, with having a device determine its own location when an event occurs.

For example, it may be expensive to provide GPS receivers in a large number of devices. In addition, the device may need to store an indication of a location when an event occurs, which would further increase the complexity and cost of the device. Moreover, it may be impractical to have a particular device, such as a handgun, receive information from satellites.

Even if a device can determine its own location, someone may tamper with the device in an attempt to alter a stored indication. For example, a competitor in a race may attempt to alter such a stored indication to unfairly improve his or her apparent performance.

Further, it is possible that a device may be accidentally lost or destroyed. In this ease, if the device had determined and stored its own location when an event occurred, such information could not be retrieved. Similarly, someone may destroy the device on purpose in an attempt to prevent others from determining the device's location when an event occurred.

### SUMMARY

To alleviate problems inherent in the prior art, the present invention introduces systems and methods wherein a base device facilitates a determination of a location associated with an occurrence of an event.

According to one embodiment of the present invention, a location of a base device is determined. The base device is in wireless communication with an event device associated with an occurrence of an event, and information is received from the event device. Information is then stored to enable a determination of a location associated with the occurrence of the event.

Another embodiment is directed to a computer-implemented method of monitoring a discharge of a weapon. According to this embodiment, global positioning system information is received indicating a location of an automobile associated with the weapon. Information is also received from the weapon via a Bluetooth communication, the received information indicating that the weapon has been discharged. Time information and location information associated with the discharge of the weapon are then stored.

According to still another embodiment, it is determined at an event device that an event has occurred. Information is transmitted to a base device, the information enabling a determination of a location associated with the occurrence of the event.

One embodiment of the present invention comprises: means for determining a location of a base device, the base device being in wireless communication with an event device associated with an occurrence of an event; means for receiving information from the event device; and means for storing information to enable a determination of a location associated with the occurrence of the event.

Another embodiment comprises: means for receiving global positioning system information indicating a location of an automobile associated with a weapon; means for receiving information from the weapon via a Bluetooth communication, the received information indicating that the weapon has been discharged; and means for storing time information and location information associated with the discharge of the weapon.

Another embodiment comprises: means for determining at an event device that an event has occurred; and means for transmitting information to a base device, the information enabling a determination of a location associated with the occurrence of the event.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of an event system according to an embodiment of the present invention.

FIG. 2 is a flow chart of a method according to an embodiment of the present invention.

FIG. 3 is a block diagram overview of a weapon system according to an embodiment of the present invention.

FIG. 4 is a block diagram overview of an event system according to another embodiment of the present invention.

FIG. 5 is a block diagram overview of a transaction system according to another embodiment of the present invention.

FIG. 6 is a block diagram of an event device according to an embodiment of the present invention.

FIG. 7 is a block diagram of a base device according to an embodiment of the present invention.

FIG. 8 is a tabular representation of a portion of an event occurrence database according to an embodiment of the present invention.

FIG. 9 is a flow chart of a method according to another embodiment of the present invention.

### DETAILED DESCRIPTION

Embodiments of the present invention are directed to systems and methods wherein a base device facilitates a determination of a location associated with an occurrence of an “event.” As used herein, the term “event” refers to anything that can occur. A discharge of a weapon, a transaction, an activation of a signal, or the provision of a medical procedure are all examples of events that can occur. Note that an event may occur substantially instantaneously (e.g., as with the discharge of a weapon) or may occur over a period of time.

Event System Overview

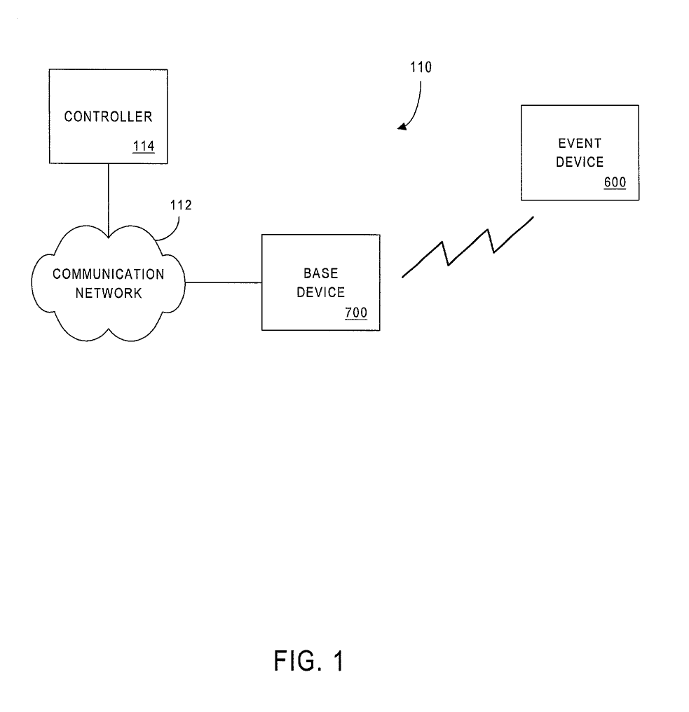

Turning now in detail to the drawings, FIG. 1 is a block diagram of an event system 110 according to one embodiment of the present invention. The event system 110 includes a base device 700 in wireless communication with an event device 600.

For example, the base device 700 may communicate with the event device 600 via a wireless Local Area Network (LAN) device (e.g., in accordance with an 802.11 standard) or a Bluetooth device. Bluetooth technology allows a wide range of computing and telecommunication devices to be interconnected via wireless connections. Specifications and other information regarding Bluetooth technology are available at the Bluetooth Web site www.bluetooth.com. In embodiments utilizing Bluetooth technology, communicating devices may be equipped with a microchip transceiver that transmits and receives information in a frequency band of 2.45 GHz (with some variation of bandwidth in different countries). Connections can be point-to-point or multipoint over a current maximum range of ten meters. Embodiments using Bluetooth technology may require the additional use of one or more communication stations (e.g., a communication station may be positioned near an automobile, and the communication station may relay information between the base device 700 and the event device 600).

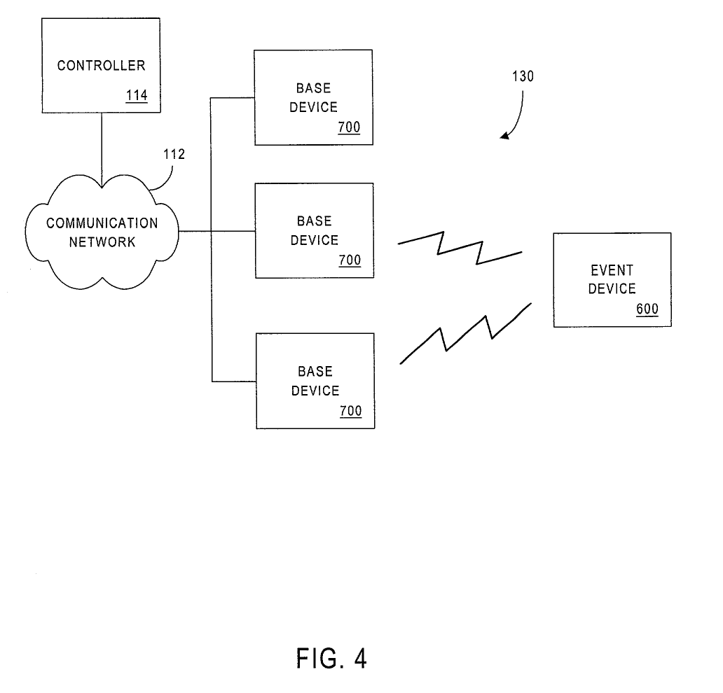

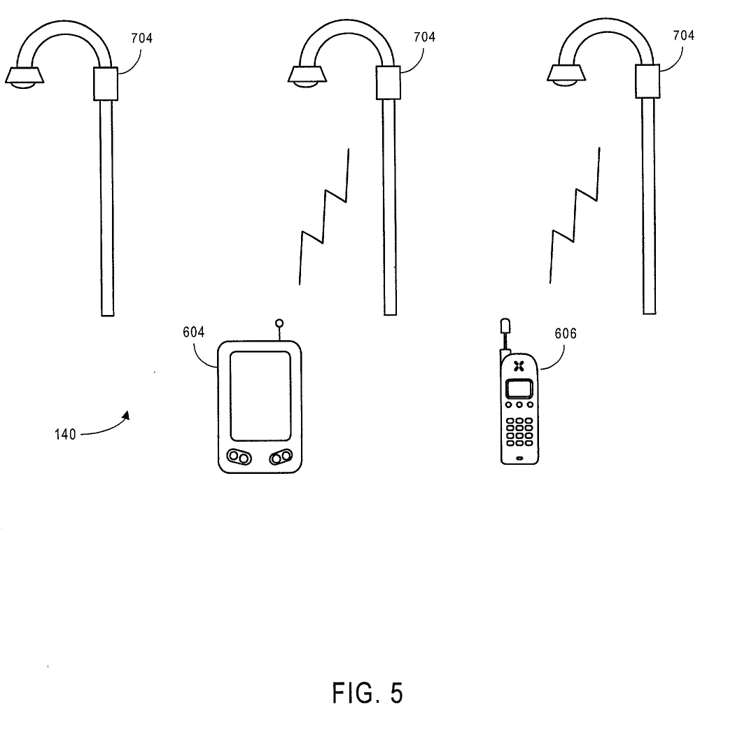

According to the present invention, a location associated with the base device 700 is determined. For example, the base device 700 may be a mobile device (e.g., an automobile or a device coupled to an automobile) adapted to determine a current location via a GPS device. According to another embodiment, the base device 700 communicates with other devices (not shown in FIG. 1) to determine a current location. According to still another embodiment described with respect to FIGS. 4 and 5, the base device 700 is stationary and can therefore be associated with a predetermined location (e.g., such as a particular street light or wireless communication tower).

The base device 700 receives information from the event device 600. For example, the event device 600 may periodically transmit information to the base device 700, including, for example, an event status (e.g., indicating that “no event has occurred” or that “an event has occurred”). According to another embodiment, the event device 600 transmits information to the base device only upon an occurrence of an event.

The information sent from the event device 600 to the base device 700 may include, for example, an event device identifier, an event identifier (e.g., representing a type of event), and/or an operator identifier (e.g., representing an operator associated with the event device 600). The information may also include an indication of an event date, time, and/or duration.

Further, the information may include, or enable a determination of, a physical relationship between the base device 700 and the event device 600 (e.g., the proximity of the event device 600). For example, the information may enable the base device 700 to calculate that the event device is within ten meters of the base device 700. Similarly, the information may indicate a current location associated with the event device 600 (e.g., a latitude and longitude) or a direction of event device 600 with respect to the base device 700 (e.g., forty five degrees to the right of the base device 700).

The base device 700 also stores information enabling a determination of a location associated with the occurrence of an event. For example, the event device 600 may determine that an event has occurred and transmit an indication of the event's occurrence to the base device 700. The base device 700 may then store, for example, the current date and time along with the current location of the base device 700. The base device 700 may also store, for example, information about the location of the event device 600 (e.g., that the event device was within ten meters of the base device 700). Other information that may be stored by the base device 700 includes, for example, a base device identifier, an event device identifier, an event identifier, and an operator identifier.

According to one embodiment, the base device 700 further stores (or arranges to store) supplemental information associated with the occurrence of the event. For example, the base device 700 may store audio information and/or image information (e.g., photographic or video image information) recorded by the base device 700 from ten seconds prior to the occurrence of the event to ten seconds after the occurrence of the event. Other types of supplemental information include, for example, orientation information, directional information (e.g., which direction a handgun was pointed when it was discharged), velocity information (e.g., how fast an automobile was moving when an accident occurred), acceleration information, and altitude information.

Note that the information transmitted from the event device 600 to the base device 700 may be encrypted to discourage someone from attempting to alter the information. Similarly, the information stored by the base device 700 may be encrypted to secure the information.

By way of example, the event device 600 may be a weapon and the base device 700 may be an automobile (or a device attached to an automobile). In this case, the automobile may use a GPS device to determine a current location. Moreover, the weapon may use a Bluetooth device to transmit an indication to the automobile each time the weapon is discharged. In this case, the automobile may record its current location when such an indication is received.

As another example, the event device 600 may comprise a medical device, such as a compact Automatic External Defibrillator (AED) device for treating cardiac arrest victims. In this case, the medical device may communicate with a base device 700 located in, for example, an ambulance.

According to one embodiment of the present invention, the base device 700 also transmits information to the event device 600, such as authorization information. For example, a handgun may not function if it is not currently receiving authorization information from a base device 700. In this case, the handgun may not discharge if it is moved too far from the base device 700 (e.g., if the handgun is stolen) or if the handgun and/or the base 700 device leave a predetermined region.

Note that although a single event device 600 is shown in FIG. 1, any number of event devices 600 may be included in the event system 110, and these event devices 600 may communicate with the base device 700 substantially simultaneously. Similarly, any number of the other devices described herein may be included in the event system 110 according to embodiments of the present invention.

As described above, the base device 700 may store information enabling a determination of a location associated with an occurrence of an event. According to another embodiment, the base device 700 arranges for such information to be stored by communicating with another device, such as a controller 114. For example, the event device 600 may determine that an event has occurred and transmit an indication of the event's occurrence to the base device 700. The base device 700 may then transmit a current location of the base device 700 and/or the event device 600 to the controller 114. The controller 114 may then store the appropriate information. Note that such a controller 144 may be able to communicate with a number of base devices 700 substantially simultaneously.

As used herein, devices (such as the base device 700 and the controller 114) may communicate via a direct connection, such as a Universal Serial Bus (USB) connection. Devices may also communicate, for example, via a communication network 112, such as a LAN, a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet. According to one embodiment, the base device 700 and the controller 114 are incorporated into a single device, such as an automobile.

Note that the devices shown in FIG. 1 need not be in constant communication. For example, the base device 700 may communicate with the controller 114 on an as-needed or periodic basis. Similarly, the base device 700 may communicate with an event device 600 only when the event device 600 is located near the base device 700.

According to one embodiment, the base device 700 further verifies that the event device 600 is authorized to exchange information. For example, only customers who subscribe to a particular event verification service may be allowed to exchange information with a base device 700.

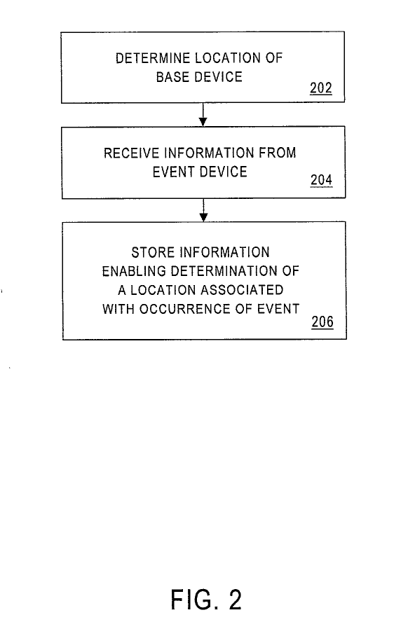

FIG. 2 is a flow chart of a method that may be performed according to the embodiment of the present invention shown in FIG. 1. The method may be performed, for example, by the base device 700. The flow charts in FIG. 2 and the other figures described herein do not imply a fixed order to the steps, and embodiments of the present invention can be practiced in any order that is practicable. Moreover, the method may instead be performed by any of the devices described herein.

At 202, a current location of a base device 700 is determined. For example, a base device 700 may receive information from one or more GPS satellites to determine a current location. At 204, information is received from an event device 600. For example, the event device 600 may transmit to the base device 700 an indication that an event has occurred.

At 206, information is stored to enable a determination of a location associated with the occurrence of the event. For example, the base device 700 may store its current location when it receives an indication from an event device 600.

According to another embodiment, the base device 700 instead continuously stores a time indication in association with a location indication (e.g., by recording its current location once every five seconds). In this case, the base device 700 may simply log a time at which an indication is received from the event device 600. The location associated with the occurrence of the event could then be determined by reviewing the stored time indications and associated location indications.

### EXAMPLE

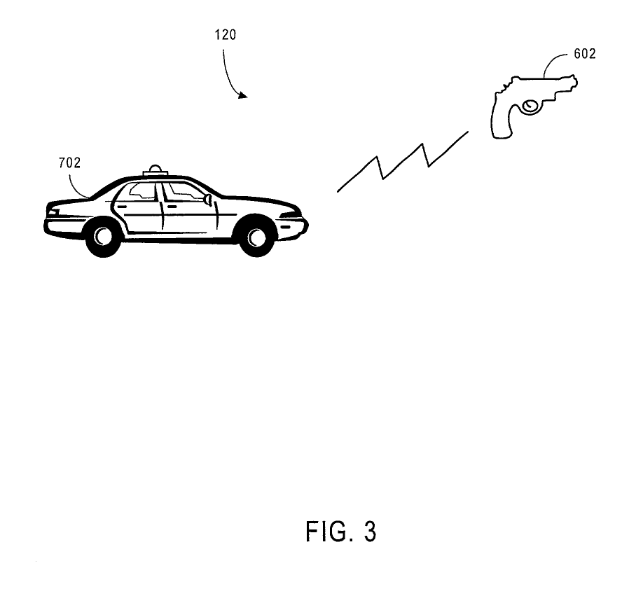

FIG. 3 is a block diagram overview of a weapon system 120 according to an embodiment of the present invention. As shown in FIG. 3, the weapon system 120 includes a police automobile 702 (which may include, or communicate with, the base device 700 described with respect to FIG. 1) and a police weapon 602.

The police automobile 702 is equipped with a GPS device that periodically calculates a current location. Both the police automobile 702 and the police weapon 602 are also equipped with Bluetooth communication devices. These devices enable the police weapon 602 to transmit an encrypted event status signal to the police automobile 702 once every second. Normally, the police automobile 702 will decrypt the received signal and determine that the event status is “not discharged.”

However, when a police officer discharges his or her police weapon 602, police weapon 602 transmits an encrypted signal to the police automobile 702 indicating that the event status is “discharged.” At this time, the police automobile 702 transmits an indication of its current location to a remote controller (not shown in FIG. 3) which records the location information along with the current date and time, a police automobile identifier, and a police weapon identifier. This information may then be trusted and used to provide evidence against a suspect.

Multiple Base Device Embodiment

FIG. 4 is a block diagram of an event system 130 according to another embodiment of the present invention. The event system 130 includes multiple base devices 700, some of which are in wireless communication with an event device 600. For example, base devices 700 may be attached to street lights throughout a city. An event device 600 may then communicate with one or more base devices 700 as it moves around the city. Note that, according to this embodiment, the location of each base device 700 may be predetermined. That is, it may not be necessary to have each base device 700 periodically determine its own location (e.g., via a GPS device). Instead, a database may simply store predetermined location information associated with each base device 700.

As described above, an event device 600 may communicate with one or more base devices 700. In this case, a current location of the event device 600 can then be approximated by evaluating which base devices 700 are currently communicating with the event device 600.

Information is received by one or more base devices 700 from the event device 600. For example, the event device 600 may broadcast to all local base devices 700 an indication that an event has occurred. Information may then be stored to enable a determination of a location associated with the occurrence of an event. For example, a controller 114 that receives information from the bases devices 700 via a communication network 112 may store an indication of which base devices 700 were communicating with the event device 600 when the event occurred.

By way of example, the event device 600 may comprise a transaction device, such as a portable computer, a Personal Digital Assistant (PDA), a wireless telephone, a payment device (e.g., a smart card), an entertainment device, a game device, or a gambling device. In this case, the controller 114 may be able to determine the location of the transaction device when a transaction occurs.

As another example, the event device 600 may comprise an automobile and the controller 114 may be able to determine a location of the automobile when an accident occurs. Similarly, the event device 600 may comprise an emergency vehicle and the controller 114 may be able to determine a location of the emergency vehicle during an emergency. Other uses for the event system 130 include determining a location of a competitor in a competition and/or a location of a security employee (e.g., a night watchperson or prison guard) when an event occurs. In this case, the event device 600 may comprise, for example, a badge or other identifier attached to a person and an “event” may comprise a beginning or end of a competition or a work shift.

FIG. 5 is a block diagram overview of a transaction system 140 according the embodiment of the present invention shown in FIG. 4. As shown in FIG. 5, a PDA 604 and a wireless telephone 606 communicate with one or more base devices 704 attached to light poles (e.g., along an interstate highway). In this case, a controller (not shown in FIG. 5) may be able to determine the location of the PDA 604 and/or the wireless telephone 606 when a transaction occurs. For example, the controller may be able to determine that a person is attempting to use his or her wireless telephone 606 to purchase a lottery ticket while he or she is outside a particular region associated with the lottery.

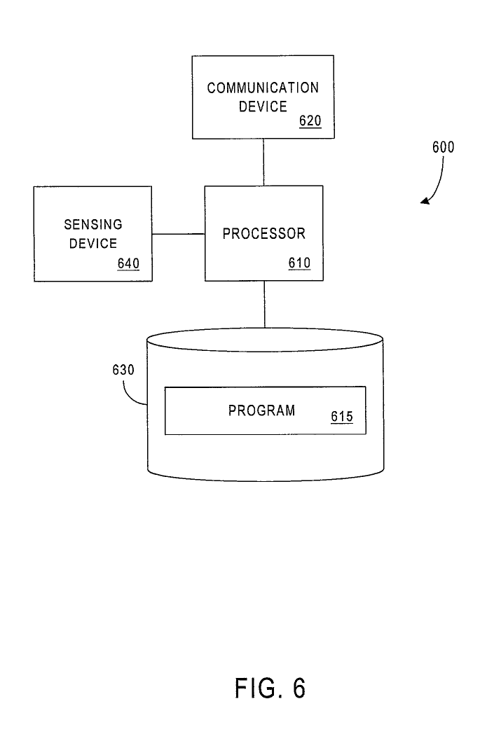

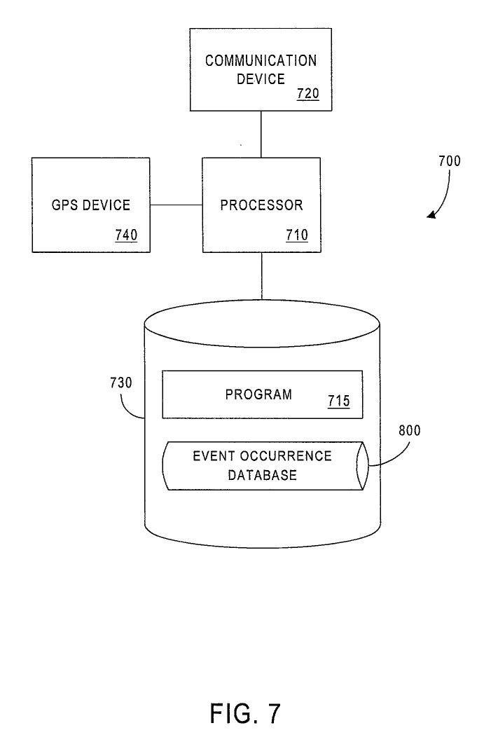

Examples of devices that may be used in connection with the systems 110, 120, 130, 140 discussed herein will now be described in detail with respect to FIGS. 6 and 7.

Event Device

FIG. 6 illustrates an event device 600 that is descriptive of the device shown, for example, in FIGS. 1 and 4 according to some embodiments of the present invention. The event device 600 comprises a processor 610, such as one or more INTEL® Pentium® processors, coupled to a communication device 620 configured to communicate via a communication network (not shown in FIG. 6). The communication device 620 may be used to communicate, for example, with one or more base devices 700.

The processor 610 is also in communication with a sensing device 640. The sensing device 640 may comprise, for example, a device adapted to sense when an event occurs. Such an sensing device 640 may be used, for example, to generate a signal to the processor 610 when an event occurs (e.g., when a handgun trigger is pulled).

The processor 610 is also in communication with a storage device 630. The storage device 630 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 630 stores a program 615 for controlling the processor 610. The processor 610 performs instructions of the program 615, and thereby operates in accordance with the present invention. For example, the processor 610 may determine that the event has occurred transmit information to a base device 700, the information enabling the determination of a location associated with the occurrence of the event.

As used herein, information may be “received” by or “transmitted” to, for example: (i) the event device 600 from the base device 700; or (ii) a software application or module within the event device 600 from another software application, module, or any other source.

Base Device

FIG. 7 illustrates a base device 700 that is descriptive of the device shown, for example, in FIGS. 1 and 4 according to some embodiments of the present invention. The event device 600 comprises a processor 710, such as one or more INTEL® Pentium® processors, coupled to a communication device 720 configured to communicate via a communication network (not shown in FIG. 7). The communication device 720 may be used to communicate, for example, with one or more event devices 600 and/or controllers 114.

The processor 710 is also in communication with a GPS device 740. The GPS device 740 may be used, for example, to determine a current location associated with the base device 700.

The processor 710 is also in communication with a storage device 730. The storage device 730 may comprise any appropriate information storage device, including combinations of magnetic storage devices (e.g., magnetic tape and hard disk drives), optical storage devices, and/or semiconductor memory devices such as RAM devices and ROM devices.

The storage device 730 stores a program 715 for controlling the processor 710. The processor 710 performs instructions of the program 715, and thereby operates in accordance with the present invention. For example, the processor 710 may determine a location of the base device 700, the base device 700 being in wireless communication with an event device 600 associated with the occurrence of the event. The processor 710 may also receive information from the event device 600 and store information to enable a determination of a location associated with the occurrence of the event.

According to one embodiment, the processor 710 receives GPS information from the GPS device 740 indicating a location of an automobile. The processor 710 also receives information from the weapon via a Bluetooth communication, the received information indicating that the weapon has been discharged. The processor 710 then stores time information and location information associated with the discharge of the weapon.

The program 715 may be stored in a compressed, uncompiled and/or encrypted format. The program 715 may furthermore include other program elements, such as an operating system, a database management system, and/or device drivers used by the processor 710 to interface with peripheral devices.

As used herein, information may be “received” by or “transmitted” to, for example: (i) the base device 700 from the event device 600; or (ii) a software application or module within the base device 700 from another software application, module, or any other source.

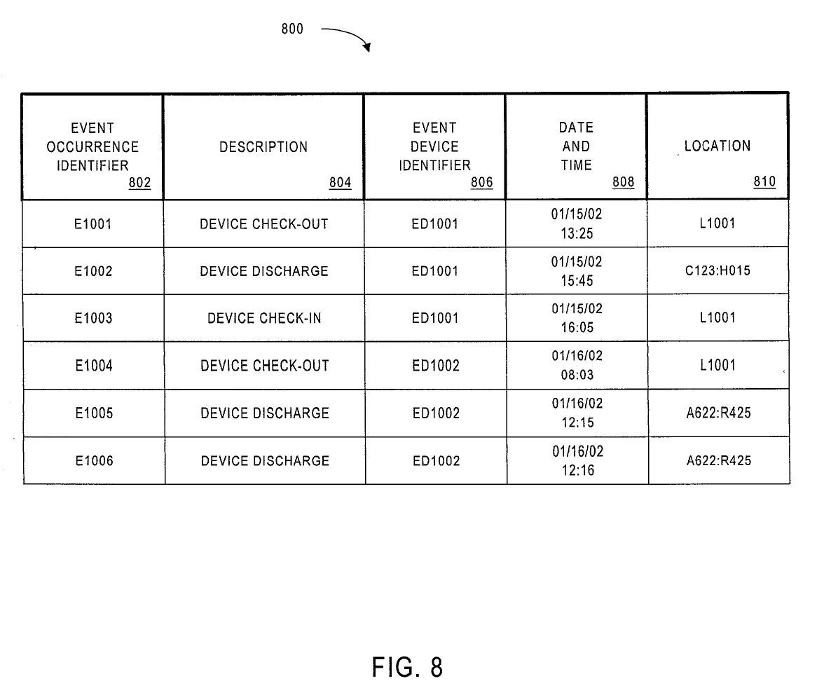

As shown in FIG. 7, the storage device 730 also stores an event occurrence database 800 (described with respect to FIG. 8). An example of a database that may be used in connection with the systems 110, 120, 130, 140 discussed herein will now be described in detail with respect to FIG. 8. The illustration and accompanying description of the database presented herein is exemplary, and any number of other database arrangements could be employed besides those suggested by the figure.

Event Occurrence Database

Referring to FIG. 8, a table represents the event occurrence database 800 that may be stored at the base device 700 according to an embodiment of the present invention. According to anther embodiment, the event occurrence database 800 is instead stored at a remote controller 114.

The table includes entries identifying events that may occur in an event system (e.g., a discharge of a weapon). The table also defines fields 802, 804, 806, 808, 810 for each of the entries. The fields specify: an event occurrence identifier 802, a description 804, an event device identifier 806, a date and time 808, and a location 810. The information in the event occurrence database 800 may be created and updated, for example, based on information received from one or more event devices 600.

The event occurrence identifier 802 may be, for example, an alphanumeric code associated with an event that has occurred. The description 804 contains information describing the event. The event device identifier 806 may be an alphanumeric code associated with an event device 600.

The date and time 808 indicate the date and time associated with the occurrence of an event (e.g., when the event occurred or when the information was recorded). The location 810 indicates a location associated with the occurrence of the event. The location may 810 may indicate a predetermined location (e.g., “L1001” may indicate a police station) or a dynamically determined location (e.g., “C123:H015” may represent coordinates on a map).

Weapon Discharge Monitoring Method

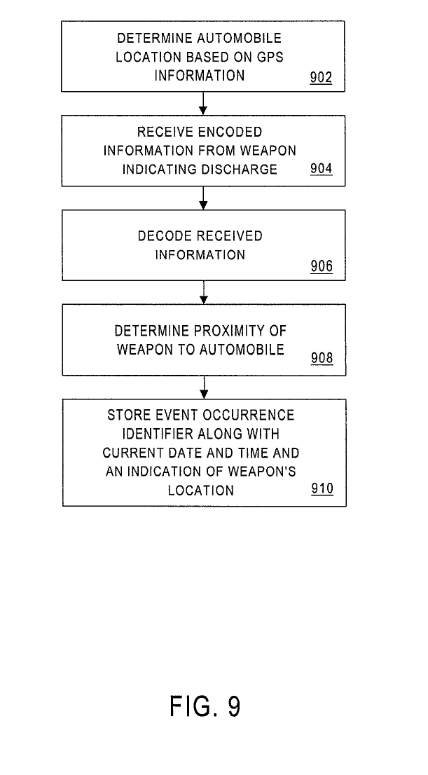

FIG. 9 is a flow chart of a computer-implemented method to monitor a discharge of a weapon according to an embodiment of the present invention. The method may be performed, for example, by a processor attached to the police automobile 702 shown in FIG. 3.

At 902, a location of the police automobile 702 is determined based on GPS information (e.g., GPS information received via the GPS device 740). At 904, encoded information is received from the police weapon 602 indicating that the weapon has been discharged. The received information is decoded at 906, and a proximity of the police weapon 602 to the police automobile 702 is determined at 908.

At 910, an event occurrence identifier 802 is stored in the event occurrence database 800 along with the current date and time 808 and an indication of the weapon's location 810 when the event occurred.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although most of the embodiments described herein are associated with the use of a GPS device to determine a current location of a base device 700, according to another embodiment the base device 700 may communicate with other devices to determine a current location. For example, the base device 700 may communicate with wireless communication towers (e.g., associated with radio or telephone communications) to determine a current location.

Similarly, although embodiments described herein are associated with a determination of a location associated with an occurrence of an event, according to other embodiments the present invention may instead be used to determine, for example, a time and/or a duration associated with the occurrence of the event.

As described herein, some or all of the information exchanged between an event device 600 and a base device 700 may be encrypted or otherwise encoded. According to one embodiment, the information is encoded using an encryption key associated with at least one of: (i) the event device, (ii) an operator associated with the event device, and (iii) the base device.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating a determination of a location associated with an occurrence of an event, comprising:
determining a location of a base device, the base device being in wireless communication with an event device associated with the occurrence of the event;
receiving information from the event device; and
storing information to enable the determination of the location associated with the occurrence of the event.

2. The method of claim 1, wherein the base device is a mobile device, and said determination of the location of the base device is performed via at least one of: (i) a global positioning system device, and (ii) a wireless communication device.

3. The method of claim 1, wherein the base device is associated with a predetermined location.

4. The method of claim 3, wherein a plurality of base devices receive information from the event device.

5. The method of claim 1, wherein the base device receives information from a plurality of event devices.

6. The method of claim 1, wherein said receiving is performed via a Bluetooth device.

7. The method of claim 1, wherein the information received from the event device comprises at least one of: (i) an event device identifier, (ii) an event identifier, (iii) an operator identifier, (iv) an indication of an event time, (v) an indication of a location, (vi) proximity information, and (vii) direction information.

8. The method of claim 1, further comprising:
transmitting information to the event device.

9. The method of claim 8, wherein the information transmitted to the event device comprises authorization information.

10. The method of claim 1, further comprising:
storing supplemental information in association with the occurrence of the event.

11. The method of claim 10, wherein the supplemental information comprises at least one of: (i) audio information, and (ii) image information.

12. The method of claim 10, wherein the supplemental information comprises at least one of: (i) orientation information, (ii) directional information, (iii) velocity information, (iv) acceleration information, and (v) altitude information.

13. The method of claim 1, wherein encrypted information is exchanged between the base device and the event device.

14. The method of claim 1, wherein the event device comprises a weapon and the event comprises a discharge of the weapon.

15. The method of claim 14, wherein the base device is associated with an automobile.

16. The method of claim 1, wherein the event device comprises a transaction device and the event comprises a transaction.

17. The method of claim 16, wherein the transaction device comprises at least one of: (i) a portable computer, (ii) a personal digital assistant, (iii) a wireless telephone, (iv) a payment device, (v) an entertainment device, (vi) a game device, and (vii) a gambling device.

18. The method of claim 1, wherein the event device comprises a competition device and the event comprises a competition event.

19. The method of claim 1, wherein the event device comprises a medical device.

20. The method of claim 1, wherein the event device comprises a security device.

21. The method of claim 1, wherein the stored information comprises at least one of (i) a base device identifier, (ii) an event device identifier, (iii) an event identifier, (iv) an operator identifier, (v) an indication of an event time, (vi) an indication of a location, (vii) proximity information, and (viii) direction information.

22. A computer-implemented method of monitoring a discharge of a weapon, comprising:
receiving global positioning system information indicating a location of an automobile associated with the weapon;
receiving information from the weapon via a Bluetooth communication, the received information indicating that the weapon has been discharged; and
storing time information and location information associated with the discharge of the weapon.

23. A method of facilitating a determination of a location associated with an occurrence of an event, comprising:
determining at an event device that the event has occurred; and
transmitting information to a base device, the information enabling the determination of the location associated with the occurrence of the event.

24. A base device, comprising:
a processor;
a wireless communication device adapted to communicate with an event device associated with an occurrence of an event; and
a storage device in communication with said processor and storing instructions adapted to be executed by said processor to:
determine a location of the base device;
receive information from the event device; and
store information to enable a determination of a location associated with the occurrence of the event.

25. The apparatus of claim 24, wherein said storage device further stores an event occurrence database.

26. An event device, comprising:
a processor;
a wireless communication device adapted to communicate with a base device; and
a storage device in communication with said processor and storing instructions adapted to be executed by said processor to:
determine that an event has occurred; and
transmit information to the base device, the information enabling a determination of a location associated with the occurrence of the event.

27. A system, comprising:
a base device, comprising:
a base device processor,
a wireless communication device adapted to communicate with an event device associated with an occurrence of an event, and
a storage device in communication with said base device processor and storing instructions adapted to be executed by said base device processor to:
determine a location of the base device,
receive information from the event device, and
store information to enable a determination of a location associated with the occurrence of the event; and
an event device, comprising:
an event device processor,
a wireless communication device adapted to communicate with said base device, and
a storage device in communication with said event device processor and storing instructions adapted to be executed by said event processor to:
determine that the event has occurred, and
transmit information to the base device, the information enabling the determination of the location associated with the occurrence of the event.

28. A medium storing instructions adapted to be executed by a processor to perform a method of facilitating a determination of a location associated with an occurrence of an event, said method comprising:
determining a location of a base device, the base device being in wireless communication with an event device associated with the occurrence of the event;
receiving information from the event device; and
storing information to enable the determination of the location associated with the occurrence of the event.
